(19) United States
(12) Patent Application Publication
(10) Pub. No.: US 2020/0134479 A1
(43) Pub. Date: Apr. 30, 2020

(54) FINE-GRAINED FORECAST DATA MANAGEMENT

(71) Applicant: Nutanix, Inc., San Jose, CA (US)

(72) Inventor: Ranjan PARTHASARATHY, Milpitas, CA (US)

(73) Assignee: Nutanix, Inc., San Jose, CA (US)

(21) Appl. No.: 16/176,444

(22) Filed: Oct. 31, 2018

(51) Int. Cl. G06N 5/02; H04L 29/08; G06F 17/30

(52) U.S. Cl. CPC G06N 5/022; G06F 17/30377; G06F 17/30309; H04L 67/1097

(57) ABSTRACT

Systems, methods and computer program products for forecast data storage. Embodiments implement fine-grained forecast data management. A cloud-based object storage system capable of storing multiple versions of an object in a container is identified. A forecast data set covering a relatively longer time period (e.g., years) is partitioned into fine-grained forecast data items corresponding to relatively shorter forecast data time periods (e.g., months, days). Some of the fine-grained forecast data items corresponding to the relatively shorter forecast data time periods are stored into a first portion of metadata of the container rather than storing the forecast data items into the object itself. Updated variations of the fine-grained forecast data items and/or new forecast data items are stored in versions of the object. A second portion of metadata of the container is used to describe a version mapping between the forecast data time periods and corresponding object versions in the container.

### FIELD

This disclosure relates to data storage, and more particularly to techniques for fine-grained forecast data management.

### BACKGROUND

Modern computing systems continue to scale to larger and larger installations. For example, some clusters in a distributed virtualization system might deploy hundreds of nodes or more that support several thousand or more autonomous virtualized entities (e.g., virtual machines, executable containers, virtual disks, etc.) that are tasked, individually or in combination, to perform one or more of a broad range of computing workloads. In many cases, one or more virtualized entities might be created to perform some set of tasks and then be terminated when the tasks are completed. As such, the topology and/or resource usage and/or available resource capacity of the computing system can be highly dynamic. Users (e.g., administrators) of such large scale, highly dynamic computing systems desire capabilities (e.g., management tools) that facilitate analyzing and/or managing computing system resources to satisfy not only the then-current demands for resources, but also foreseeable demands for resources. For example, administrators might desire capabilities that facilitate cluster management (e.g., deployment, maintenance, scaling, etc.), virtualized entity management (e.g., creation, placement, sizing, protection, migration, etc.), storage management (e.g., allocation, policy compliance, location, etc.), and/or management of any other aspects pertaining to the computing system.

Providers of modern computing systems address the aforementioned system management needs at least in part by implementing various system monitoring and resource usage forecasting capabilities in the systems. Such capabilities monitor the resource usage activity at a computing system to generate estimated (e.g., predicted) resource usage forecasts. The forecast data can then be used by an administrator to, for example, determine when a particular resource or set of resources might be scaled up or scaled down. Various forecasting algorithms might be implemented by the system providers based on the scenarios planning objectives of the administrators.

In large scale, highly dynamic computing systems, the volume of forecast data produced and managed at a particular system can be substantial. As such, system providers may desire to store the forecast data in a cloud-based object storage environment, rather than store and manage the forecast data in a specialized database that is internal to the computing system. The foregoing preference is due at least in part to the lower cost of using the cloud-based object storage environment as compared to using the aforementioned internal database. One approach for storing forecast data in a cloud-based object store (e.g., Amazon S3) forms an object comprising the entire set of forecast data for a particular metric that is uploaded to a container in the object store. For example, the object might correspond to a CPU utilization metric associated with a virtual machine (VM), and the object content might describe the expected weekly CPU utilization percentage of the VM over an 18-month (e.g., 78-week) forecast period. To access the forecast data associated with a particular week (e.g., to update the data, to add an actual measured value to the data, etc.), the entire data set is downloaded, modified, and then uploaded as another version of the object in the container.

Unfortunately, the foregoing update operations and/or other operations pertaining to forecast data objects stored in cloud-based object storage environments can be costly. Furthermore, such costs increase commensurate with the frequency of accesses to the forecast data objects, and/or scaling of various aspects of the subject computing system such as the number and/or composition of virtualized entities, the number of monitored metrics, the range of planning requirements and/or objectives, and/or other aspects. What is needed is a way to efficiently manage large, highly dynamic forecast data sets that are stored in cloud-based object storage environments.

### SUMMARY

The present disclosure describes techniques used in systems, methods, and in computer program products for fine-grained forecast data management, which techniques advance the relevant technologies to address technological issues with legacy approaches. More specifically, the present disclosure describes techniques used in systems, methods, and in computer program products for fine-grained management of forecast data in a cloud-based object storage environment. Certain embodiments are directed to technological solutions for accessing object metadata in a cloud-based object storage environment to map the versions of objects comprising forecast data to fine-grained forecast data time periods associated with the forecast data.

The disclosed embodiments modify and improve over legacy approaches. In particular, the herein-disclosed techniques provide technical solutions that address the technical problems attendant to efficiently managing large, highly dynamic forecast data sets stored in cloud-based object storage environments. Such technical solutions involve specific implementations (i.e., data organization, data communication paths, module-to-module interrelationships, etc.) that relate to the software arts for improving computer functionality. Various applications of the herein-disclosed improvements in computer functionality serve to reduce demands for computer memory, reduce demands for computer processing power, reduce network bandwidth use, and reduce demands for inter-component communication. For example, when performing computer operations that address the various technical problems underlying efficiently managing large, highly dynamic forecast data sets stored in cloud-based object storage environments, both memory usage and network bandwidth demanded are significantly reduced as compared to the memory usage and network bandwidth that would be needed but for practice of the herein-disclosed techniques.

The ordered combination of steps of the embodiments serve in the context of practical applications that perform steps for accessing object metadata that is stored in a cloud-based object storage environment to map the versions of objects comprising forecast data to the time periods associated with the forecast data. The ordered combination of steps are more efficient at least in that accessing and manipulating only the metadata pertaining to the particular forecast data set pertaining to a particular date of interest, is much more efficient than having to access and manipulate the entire forecast data set covering the entire forecast period. As such, the disclosed techniques for accessing object metadata in a cloud-based object storage environment to map the versions of objects comprising forecast data to the time periods associated with the forecast data overcomes various technological problems that arise when using cloud-based storage objects. Aspects of the present disclosure achieve performance and other improvements in peripheral technical fields including (but not limited to) hyperconverged computing platform management and data storage.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 illustrates a storage environment in which embodiments of the present disclosure can be implemented.

FIG. 2 depicts a fine-grained forecast data management technique as implemented in systems that facilitate fine-grained management of forecast data in a cloud-based object storage environment, according to an embodiment.

FIG. 3 is a block diagram of a system that implements fine-grained management of forecast data in a cloud-based object storage environment, according to an embodiment.

FIG. 4 presents a forecast data object storage technique as implemented in systems that facilitate fine-grained management of forecast data in a cloud-based object storage environment, according to an embodiment.

FIG. 5 depicts a forecast data object update technique as implemented in systems that facilitate fine-grained management of forecast data in a cloud-based object storage environment, according to an embodiment.

FIG. 6 illustrates a forecast data presentation technique as implemented in systems that facilitate fine-grained management of forecast data in a cloud-based object storage environment, according to an embodiment.

FIG. 7A and FIG. 7B depict system components as arrangements of computing modules that are interconnected so as to implement certain of the herein-disclosed embodiments.

FIG. 8A, FIG. 8B, and FIG. 8C depict virtualized controller architectures comprising collections of interconnected components suitable for implementing embodiments of the present disclosure and/or for use in the herein-described environments.

### DETAILED DESCRIPTION

Aspects of the present disclosure may solve problems associated with using computer systems for efficiently managing large, highly dynamic forecast data sets stored in cloud-based object storage environments. These problems are unique to, and may have been created by, various computer-implemented methods for efficiently managing large, highly dynamic forecast data sets stored in cloud-based object storage environments in legacy systems. Some embodiments are directed to approaches for accessing object metadata in a cloud-based object storage environment to map the versions of objects comprising forecast data to the time periods associated with the forecast data. The accompanying figures and discussions herein present example environments, systems, methods, and computer program products for fine-grained management of forecast data in a cloud-based object storage environment.

### Overview

Disclosed herein are techniques for accessing object metadata in a cloud-based object storage environment to map the versions of objects comprising forecast data to the time periods associated with the forecast data. In certain embodiments, a cloud-based object storage environment that is capable of storing multiple versions of an object with an associated set of metadata is identified and the metadata is used to store correlations between forecast time periods and corresponding forecast data.

Certain cloud-based object storage environments support storing a correlation between forecast time periods together with corresponding forecast data by maintaining metadata associations between content objects in a storage container and any number of versions of those content objects. To take advantage of this association that is at least partially built in to the mechanisms of certain cloud-based object storage environments, a forecast date is associated with a version of a content object. As such, then using only the metadata of the storage container, associations between forecast data items and the dates corresponding to those forecast data items can be maintained.

In many cases, multiple forecast data items can be associated with a particular date and stored in metadata of the container—without needing to store the multiple forecast data items in the version object itself. More specifically, to associate a forecast date with a version of a content object, each particular version of the content object is associated with an identifier. The identifier might correlate to a performance metric (e.g., CPU utilization), and a set of forecast data corresponding to the identifier might comprise forecasted values for that metric. Each set of forecast data is partitioned into time slices in accordance with the time periods associated with the forecasted values in the forecast data. Strictly as an illustrative example, the forecast data might comprise an estimated weekly CPU utilization percentage for the next 18 months (e.g., 78 weeks). In this case, the forecast data can be partitioned into 78 time slices that each correspond to a particular weekly forecast (e.g., “week01” forecast, “week02” forecast, etc.). An instance of an object referenced by the object identifier is generated for each of the forecast data time slices. Each object instance associated with a respective forecast data time slice is then uploaded to the cloud-based object storage environment as a unique version of the object.

Information that maps the system-generated version of each object instance to a time slice identifier (e.g., “week01”, “week02”, etc.) is stored in the object metadata associated with the object. The time-based version mapping in the object metadata can be accessed to perform efficient, fine-grained (e.g., by time slice) updates and/or other management operations over the forecast data stored in the cloud-based object storage environment. In certain embodiments, a time slice can refer to a past, current, or future moment in time. In certain embodiments, the duration of the time slices is determined based at least in part on the forecast data. In certain embodiments, forecast summary data and/or other data can be recorded in the object metadata. In certain embodiments such as when the extent of the forecast data exceeds storage space available in the metadata, any amount of additional forecast data and/or other data can be recorded in the object itself.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

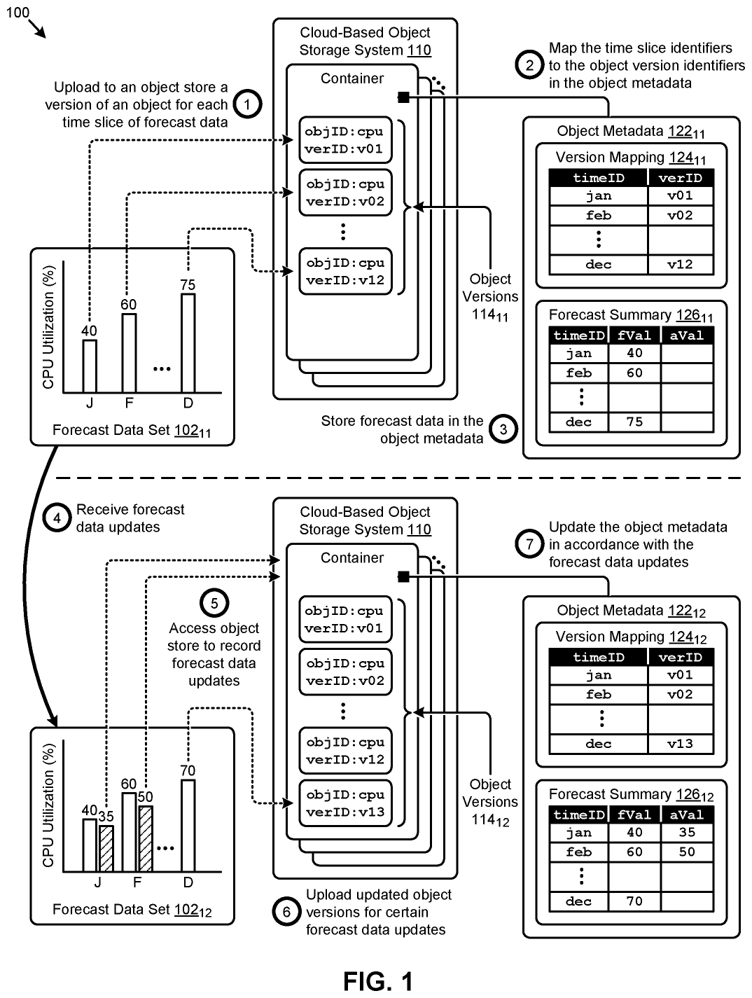

FIG. 1 illustrates a storage environment 100 in which embodiments of the present disclosure can be implemented. The shown storage environment 100 includes a cloud-based object storage system 110. Unlike hierarchical file systems, in which individual fine-grained items (e.g., files) can be accessed individually and small portions can be written over with a block write to the file, storage systems such as cloud-based object storage system 110 support objects that are only retrievable in its entirety and only savable in its entirety. As such, an update to any portion of an object, regardless of how small the update might be, requires that the object be retrieved in its entirety and then saved in its entirety with the update. Even if the modification is very small (e.g., 1 byte of information), the object must be retrieved in its entirety and then saved in its entirety in a READ_MODIFY-WRITE cycle.

In cloud-based object storage systems, this introduces inefficiencies. Specifically, each and every time there is any update to the object, and each and every time there is a retrieval of the object, the entire object must be retrieved. For a large object (e.g., a megabyte of data) that has small updates (e.g., one byte of data) the inefficiency becomes extreme, and becomes even more extreme when the object is frequently accessed even for a READ without a WRITE. In the foregoing example, the inefficiency on the order of one million. This situation is exacerbated when the object is accessed frequently, even if only for READs of the object.

The illustrative embodiment of FIG. 1 illustrates a forecast data set 102₁₁ that is a representative example of such large and highly dynamic forecast data sets associated with a computing system. A forecast data set is a set of data that includes at least some predicted data (e.g., forecasted value) for a time period (e.g., future time period) that is later than the moment in time at which the predicted data was established. At any moment in time, a forecast data set can comprise data that is associated with past time periods, current time periods, and future time periods. A forecast data set can comprise predicted data and actual (e.g., observed, measured, etc.) data.

The scope and purpose of a forecast data set can vary. As shown, forecast data set 102₁₁ pertains to forecasted values for a “CPU Utilization” metric (e.g., specified as a percentage of a total available CPU capacity). Specifically, monthly CPU utilization percentage estimates (e.g., “40”, “60”, . . . , “75”) over 12 calendar months (e.g., “J” or January, “F” or February, . . . , “D” or December) can be derived from forecast data set 102₁₁. As an example, the scope of the CPU utilization estimates might be such that the estimates are an aggregate utilization over the entire computing system. In this case, the underlying data of forecast data set 102₁₁ might comprise CPU utilization estimates for each subsystem (e.g., node) and/or entity (e.g., virtual machine) in the computing system that can be summarized in the shown monthly estimates. The underlying data of forecast data set 102₁₁ might also comprise utilization estimates for time periods (e.g., week, day, etc.) that are subsets of a reported time period (e.g., month). Furthermore, a forecast data set might comprise other information pertaining to the forecasted data, such as system conditions, system configurations, prediction algorithm parameters, and/or other information.

Due to the large and highly dynamic nature the computing system forecast data that comprise forecast data set 102₁₁, there is a desire to store forecast data set 102₁₁ and the entire corpus of forecast data at a cloud-based object storage system 110 rather than store and manage the forecast data in a specialized database that is internal to the computing system. The foregoing preference is due at least in part to the lower cost of using the cloud-based object storage environment as compared to using the aforementioned internal database. However, when using certain approaches to store forecast data sets as objects in a cloud-based object storage environment, performing update operations and/or other operations over the forecast data sets can be costly.

The herein disclosed techniques address such problems attendant to efficiently managing large, highly dynamic forecast data sets stored in cloud-based object storage environments as illustrated in FIG. 1. Specifically, rather than store the entire set of data comprising forecast data set 102₁₁ in an object at cloud-based object storage system 110, forecast data set 102₁₁ is partitioned into forecast data time slices and a distinct version of an object that comprises the forecast data of a respective time slice is uploaded into a container at a cloud-based object storage system 110 (operation 1). For example, a container might be populated with a version of forecast data object (e.g., “objID=cpu”) that corresponds to a performance metric (e.g., “CPU Utilization”) of forecast data set 102₁₁. In the specific scenario shown in FIG. 1, forecast data set 102₁₁ is partitioned into 12 forecast data time slices corresponding to each of the 12 months represented in the data set. As such, a set of object versions 114₁₁ (e.g., versions “v01”, “v02”, . . . , “v12”) corresponding to the forecast data time slices are stored in a container at the cloud-based object storage system 110.

The term container as used herein refers to any logical or physical boundary of a storage area where one or more versions of an object can be persistently stored. In some cloud-based storage systems, a container is termed a bucket. In other cloud-based storage systems, a container is termed an object store. In still other cloud-based storage systems, a container might be a file or archive that is accessible as a whole rather than being accessible by its constituent blocks of storage.

A forecast data time slice, as used herein, is a portion of a forecast data set that is associated with a particular time period. In some cases, the time period of the forecast is equal to the time period associated with the predicted data in the forecast data set. For example, weekly performance estimates might be partitioned into weekly time slices. In other cases, the time period of the forecast data time slice is longer than the time period associated with the predicted data in the forecast data set. For example, weekly performance estimates are partitioned into monthly or quarterly time slices. In these cases, certain summary operations might be performed to translate the underlying predicted data to the predicted data associated with the forecast data time slices.

To access and/or otherwise manage the forecast data time slices, time slice identifiers associated with the forecast data time slices are mapped to version identifiers associated with object versions 114₁₁ in a set of object metadata 122₁₁ (operation 2). Since the version identifiers of an object version in a container are often specified by cloud-based object storage system 110—and are not modifiable by a user—a version mapping 124₁₁ is established in object metadata 122₁₁ to identify and access a particular forecast data time slice. The time slice identifiers used in version mapping 124₁₁ are often a date and/or time value that uniquely identifies (and describes) each forecast data time slice of a forecast data set. As shown in version mapping 124₁₁, time slice identifiers (e.g., associated with a “timeID” attribute) that indicate the month of the respective forecast data time slices are associated with the system-generated version identifiers (e.g., associated with a “verID” attribute) of object versions 114₁₁.

As can be observed, certain summary data pertaining to the forecast data time slices can also be stored in object metadata 122₁₁ (operation 3). Specifically, a forecast summary 126₁₁ can comprise attributes that associate time slice identifiers (e.g., associated with a “timeID” attribute) to various summary attributes such as forecasted values (e.g., associated with an “fVal” attribute) and/or actual values (e.g., associated with an “aVal” attribute).

Version mapping 124₁₁ and forecast summary 126₁₁ in object metadata 122₁₁ also facilitate efficient management of updates to forecast data set 102₁₁. As illustrated in FIG. 1, various updates to forecast data set 102₁₁ might be received in a forecast data set 102₁₂ (operation 4). In response to receiving the forecast data updates, the container of the cloud-based object storage system is accessed to record the updates (operation 5). In some cases, the forecast data updates might result in uploading an updated object version to cloud-based object storage system 110 (operation 6). For example, forecast data set 102₁₂ includes a change to the forecasted value (e.g., “70”) for December (e.g., “D”). Such a change to a forecasted value is often a result of changes to the information (e.g., system conditions, system configurations, prediction algorithm parameters, etc.) comprising the forecast data time slice. As such, a new object version (e.g., version “v13”) is uploaded to cloud-based object storage system 110 to comprise an updated set of object versions 11412.

In response to receiving the forecast data updates, the object metadata is also updated (operation 7). Specifically, object metadata 122₁₂ includes a mapping between the “dec” forecast data time slice and the update object version “v13” in version mapping 124₁₂. Forecast summary 126₁₂ in object metadata 122₁₂ includes the updated forecast value (e.g., “fVal=70”) for the “dec” forecast data time slice. Actual values (e.g., “aVal=35” and “aVal=50”) included in forecast data set 102₁₂ for the “jan” and “feb” forecast data time slices are also recorded in forecast summary 126₁₂.

The foregoing time-based version mapping and forecast summaries in the object metadata and/or other techniques described herein facilitate efficient, fine-grained (e.g., by time slice) updates and/or other management operations over forecast data sets stored in cloud-based object storage environments. Such fine-grained forecast data management capabilities facilitated by the herein disclosed techniques result in improvements in computer functionality that serve to reduce the demand for computer processing power, reduce the demand for computer memory and data storage, reduce network bandwidth use, and reduce the demand for inter-component communication in computing environments. Specifically, applications of the herein disclosed techniques reduce the consumption of computing and networking resources by performing many management operations over a forecast data set by accessing and manipulating merely the metadata pertaining to the updated time slice of the forecast data set, rather than by accessing and manipulating the data pertaining to the entire forecast data set.

One embodiment of techniques for such fine-grained forecast data management is disclosed in further detail as follows.

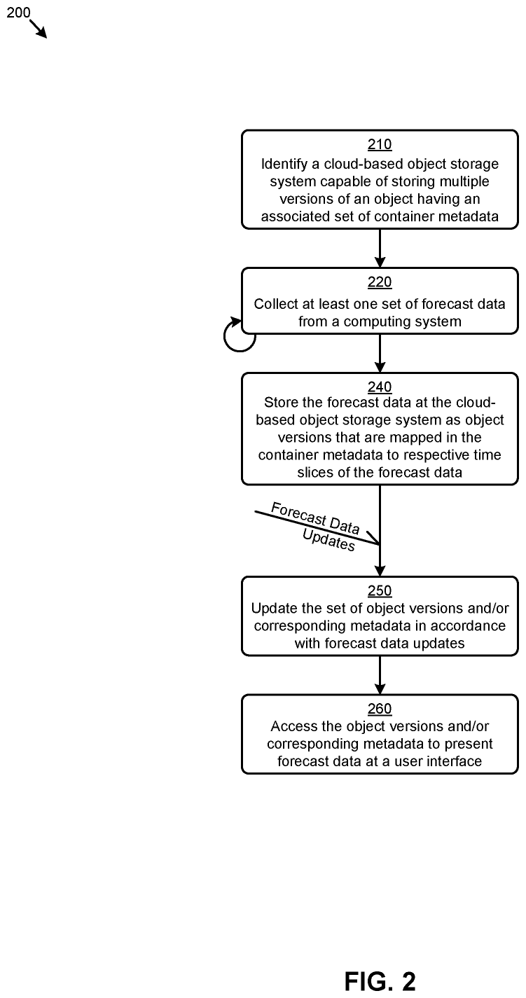

FIG. 2 depicts a fine-grained forecast data management technique 200 as implemented in systems that facilitate fine-grained management of forecast data in a cloud-based object storage environment. As an option, one or more variations of fine-grained forecast data management technique 200 or any aspect thereof may be implemented in the context of the architecture and functionality of the embodiments described herein. The fine-grained forecast data management technique 200 or any aspect thereof may be implemented in any environment.

FIG. 2 illustrates one aspect pertaining to accessing object metadata in a cloud-based object storage environment to map the versions of objects comprising forecast data to the time periods associated with the forecast data. Specifically, the figure is presented to illustrate one embodiment of certain steps and/or operations for efficiently managing large, highly dynamic forecast data sets stored in cloud-based object storage environments.

The fine-grained forecast data management technique 200 can commence by identifying a cloud-based object storage system that is capable of storing multiple versions of an object that has an associated set of metadata (step 210). As merely one example, the cloud-based object storage system might be Amazon's Simple Storage Service (e.g., Amazon S3) with object versioning enabled. When an object version is enabled in Amazon S3, each instance of an uploaded object will be assigned a system-generated version identifier. At least one set of forecast data pertaining to a computing system is collected (step 220). In most modern computing environments, multiple forecast data sets pertaining to a computing system are created and continually maintained. As earlier described, such forecast data sets are maintained to provide system administrators an ability to analyze and/or manage computing system resources so as to satisfy not only the then-current demands for resources, but also the foreseeable demands for resources.

According to fine-grained forecast data management technique 200 and/or other techniques disclosed herein, the forecast data is stored at the cloud-based object storage system as object versions that are mapped in the container metadata to respective forecast data time slices (step 240). As an example, a forecast data set comprising weekly data might be partitioned into forecast data time slices that correspond to each week of data in the forecast data set. As forecast data updates are received, the set of object versions and/or corresponding metadata are updated in accordance with the forecast data updates (step 250). For example, some portions of the forecast data updates might invoke a new object version to be created and uploaded, while other portions of the forecast data updates might merely invoke changes to corresponding metadata. At any moment in time, the object versions and/or corresponding metadata can be accessed to present the forecast data at a user interface (step 260). Certain presentations of the forecast data might require access to merely the container metadata and/or merely one object version (e.g., one forecast data time slice), rather than requiring access to the entire set of forecast data.

One embodiment of a system, data flows, and data structures for implementing fine-grained forecast data management technique 200 and/or other herein disclosed techniques is disclosed as follows.

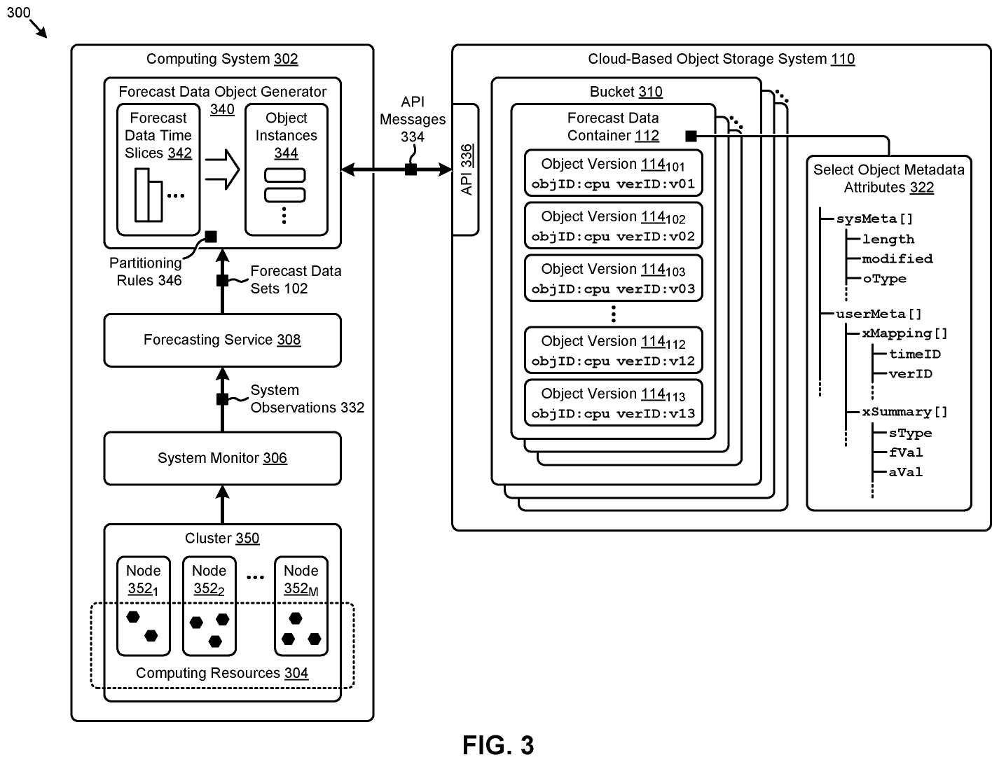

FIG. 3 is a block diagram of a system 300 that implements fine-grained management of forecast data in a cloud-based object storage environment. As an option, one or more variations of system 300 or any aspect thereof may be implemented in the context of the architecture and functionality of the embodiments described herein. The system 300 or any aspect thereof may be implemented in any environment.

FIG. 3 illustrates one aspect pertaining to accessing object metadata in a cloud-based object storage environment to map the versions of objects comprising forecast data to the time periods associated with the forecast data. Specifically, the figure is being presented to show one embodiment of certain representative components and associated data flows that describes how the herein disclosed techniques might be implemented in a computing environment that comprises cloud-based object storage system 110 and one or more instances of a computing system 302 for which various forecast data sets are generated and maintained. Also illustrated are various specialized data structures that improve the way a computer uses data in memory when performing steps pertaining to efficiently managing large, highly dynamic forecast data sets associated with computing system 302 that are stored in cloud-based object storage system 110. The components, data flows, and data structures shown in FIG. 3 present one partitioning and associated data manipulation approach. The specific example shown is purely exemplary, and other subsystems, data structures, and/or partitioning are reasonable.

As shown, computing system 302 comprises at least one cluster 350 that comprises multiple nodes (e.g., node 352₁, node 352₂, . . . , node 352_{M}). The nodes comprise a set of computing resources 304 that an administrator might want to manage the computing system so as to satisfy both the then-current as well as forthcoming demands for resources. As an example, computing resources 304 might comprise various processing (e.g., CPU), networking, and storage resources associated with the nodes that are shared over many virtualized entities (e.g., virtual machines, virtual disks, etc.) in a virtualized computing environment. To facilitate such computing resource analyses and management, a system monitor 306 and a forecasting service 308 are implemented in computing system 302. System monitor 306 accesses cluster 350 to continually collect various instances of system observations 332 pertaining to conditions, configurations, resource usage, and/or other aspects of cluster 350. System observations 332 are accessed by forecasting service 308 to generate one or more forecast data sets 102. Forecast data sets 102 might correspond to performance metrics (e.g., a CPU utilization metric, a storage utilization metric, a network bandwidth utilization metric, etc.) associated with cluster 350, one or more nodes, and/or one or more entities (e.g., virtualized entities, workloads, projects, user groups, etc.). Other scopes associated with forecast data sets 102 are possible.

According to the embodiment of FIG. 3, the herein disclosed techniques are facilitated by a forecast data object generator 340 implemented at computing system 302. As can be observed, forecast data object generator 340 partitions the forecast data sets 102 received from forecasting service 308 into forecast data time slices 342. For example, the instances of forecast data time slices 342 associated with a particular instance of forecast data sets 102 might be determined at least in part on certain partitioning rules 346 and/or partitioning directives established by an administrator. A set of object instances 344 that correspond to forecast data time slices 342 are generated by forecast data object generator 340. Each of the object instances 344 comprise data that is associated with its respective forecast data time slice. For example, an object instance might comprise the predicted value or values, the time period characteristics (e.g., timestamp), and the underlying information (e.g., conditions, configurations, algorithm parameters, etc.) associated with a respective forecast data time slice.

Object instances 344 are uploaded to cloud-based object storage system 110 using various instances of API messages 334 issued to an API 336. For example, API 336 might be a REST API and API messages 334 might be HTTP calls that reference a particular bucket 310, and/or that reference a particular one of any number of containers within the bucket and/or an object identifier (e.g., “objID=cpu”) for forecast data within the container. As used herein, a bucket is a logical or physical construction that may be associated with a particular tenant. A tenant may use any number of buckets, and a bucket may store any number of containers.

In this case, a series of PUT (or POST) calls issued to API 336 to upload a set of corresponding object instances associated with forecast data container 112 can result in a set of stored object versions (e.g., object version 114₁₀₁, object version 114₁₀₂, object version 114₁₀₃, . . . , object version 114₁₁₂, and object version 114₁₁₃) associated with forecast data container 112. Other types of API messages 334 are possible. For example, API messages can be issued to perform read (e.g., download) operations, delete operations, and/or other operations over bucket 310 and/or its constituent containers, and/or constituent object versions. API messages 334 might also be issued to manage a set of object metadata associated with any object at cloud-based object storage system 110.

As indicated in a set of select object metadata attributes 322, the object metadata associated with any object at cloud-based object storage system 110 can store a variety of information. Select object metadata attributes 322 and/or any other data described herein can be organized and/or stored using various techniques. For example, select object metadata attributes 322 indicate that object metadata might be organized and/or stored in a tabular structure (e.g., relational database table) that has rows that relate various object attributes with a particular object. As another example, the information might be organized and/or stored in a programming code object that has instances corresponding to a particular object and properties corresponding to the various attributes associated with the object. The attributes of the object metadata might also be recorded as key-value pairs each having a key that identifies a particular attribute and a value that corresponds to the value of the attribute to be recorded. In some cases, a key-value pair might correspond to an attribute group. As such the value of the key-value pair might comprise a formatted string (e.g., CSV, JSON, XML, etc.) to record a list of values (e.g., corresponding to multiple prediction algorithms), a hierarchy of values (e.g., corresponding to a group of attributes), and/or other information pertaining to the attribute group.

As depicted in FIG. 3, select object metadata attributes 322 indicate a set of object metadata for a particular object comprises system metadata (e.g., associated with a “sysMeta[ ]” attribute group) that records an object length (e.g., associated with a “length” attribute), a timestamp corresponding to when the object was last modified (e.g., associated with a “modified” attribute), a description of an object type (e.g., associated with an “oType” attribute), and/or other information associated with an object. Furthermore, select object metadata attributes 322 indicate a set of object metadata for a particular object comprises user metadata (e.g., associated with a “userMeta[ ]” attribute group) that in turn comprises version mapping attributes (e.g., associated with an “xMapping[ ]” attribute group) and forecast summary attributes (e.g., associated with an “xSummary[ ]” attribute group). As can be observed, each instance of the version mapping attributes can include a time slice identifier (e.g., associated with a “timeID” attribute), a version identifier (e.g., associated with a “verID” attribute), and/or other version mapping attributes. Furthermore, each instance of the forecast summary attributes can include a description of the summary type (e.g., associated with an “sType” attribute), a forecast value (e.g., associated with an “fVal” attribute), an actual value (e.g., associated with an “aVal” attribute), and/or other forecast summary attributes. In some cloud-based object storage environments (e.g., Amazon S3), the set of user metadata in the object metadata can be configured by a user (e.g., administrator). For example, the object metadata associated with the “userMeta[ ]” attribute group might be configured to record one or more attributes in the object metadata so as to facilitate the herein disclosed techniques.

The foregoing discussions include techniques for storing forecast data time slices as object versions in a cloud-based object storage system (e.g., step 240 of FIG. 2), which techniques are disclosed in further detail as follows.

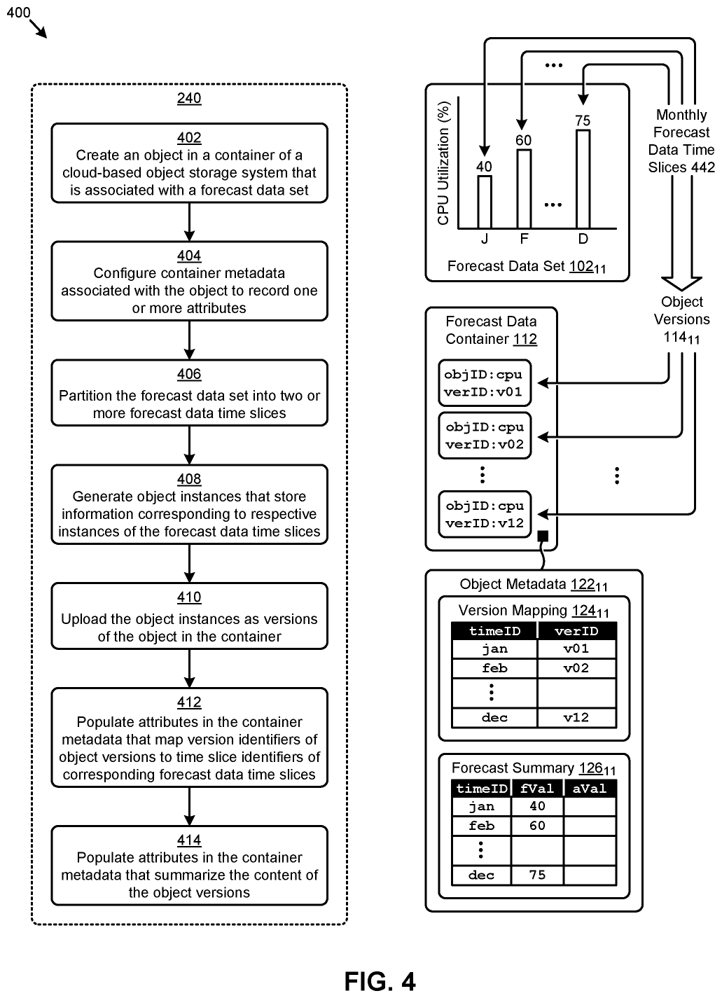

FIG. 4 presents a forecast data object storage technique 400 as implemented in systems that facilitate fine-grained management of forecast data in a cloud-based object storage environment. As an option, one or more variations of forecast data object storage technique 400 or any aspect thereof may be implemented in the context of the architecture and functionality of the embodiments described herein. The forecast data object storage technique 400 or any aspect thereof may be implemented in any environment.

FIG. 4 illustrates one aspect pertaining to accessing object metadata in a cloud-based object storage environment to map the versions of objects comprising forecast data to the time periods associated with the forecast data. Specifically, the figure is presented to illustrate one embodiment of certain steps and/or operations that facilitate storing forecast data time slices as object versions in a cloud-based object storage system. A representative scenario is also shown in the figure to illustrate an example application of the forecast data object storage technique 400.

The forecast data object storage technique 400 can commence by creating an object in a container of a cloud-based object storage system that is associated with a particular forecast data set (step 402). For example, forecast data container 112 might be populated with an object identifier of “cpu” to store forecast data (e.g., forecast data set 102₁₁) associated with a CPU utilization performance metric. The metadata associated with the object is configured to record one or more attributes (step 404). As shown in the representative scenario, object metadata 122₁₁ associated with a corresponding forecast data container can be configured to store attributes that describe a version mapping 124₁₁ and/or a forecast summary 126₁₁.

The forecast data set associated with the object is partitioned into two or more forecast data slices (step 406). As an example, forecast data set 102₁₁ is partitioned into a set of monthly forecast data time slices 442. Object instances that store information corresponding to respective instances of forecast data time slices are generated (step 408) and uploaded as versions of the object in the container (step 410). Each object version from object versions 114₁₁ shown in FIG. 4 corresponds to a respective one of the monthly forecast data time slices 442. One or more attributes in the container metadata are populated to map version identifiers of object versions to time slice identifiers of corresponding forecast data time slices (step 412). As can be observed, the attributes comprising version mapping 124₁₁ in object metadata 122₁₁ associate certain time slice identifiers (e.g., “jan”, “feb”, . . . , “dec”) with certain respective version identifiers (e.g., “v01”, “v02”, . . . , “v12”). In some cases, one or more attributes in the metadata are populated to summarize certain content (e.g., data, information, etc.) comprising the object versions (step 414). For example, the attributes comprising forecast summary 126₁₁ in object metadata 122₁₁ associate certain time slice identifiers (e.g., “jan”, “feb”, . . . , “dec”) with certain respective summary attributes (e.g., forecasted values “40”, “60”, . . . , “75”).

The foregoing discussions include techniques for updating object versions and/or object metadata associated with a forecast data object stored at a cloud-based object storage system in response to receiving one or more forecast data updates (e.g., step 250 of FIG. 2), which techniques are disclosed in further detail as follows.

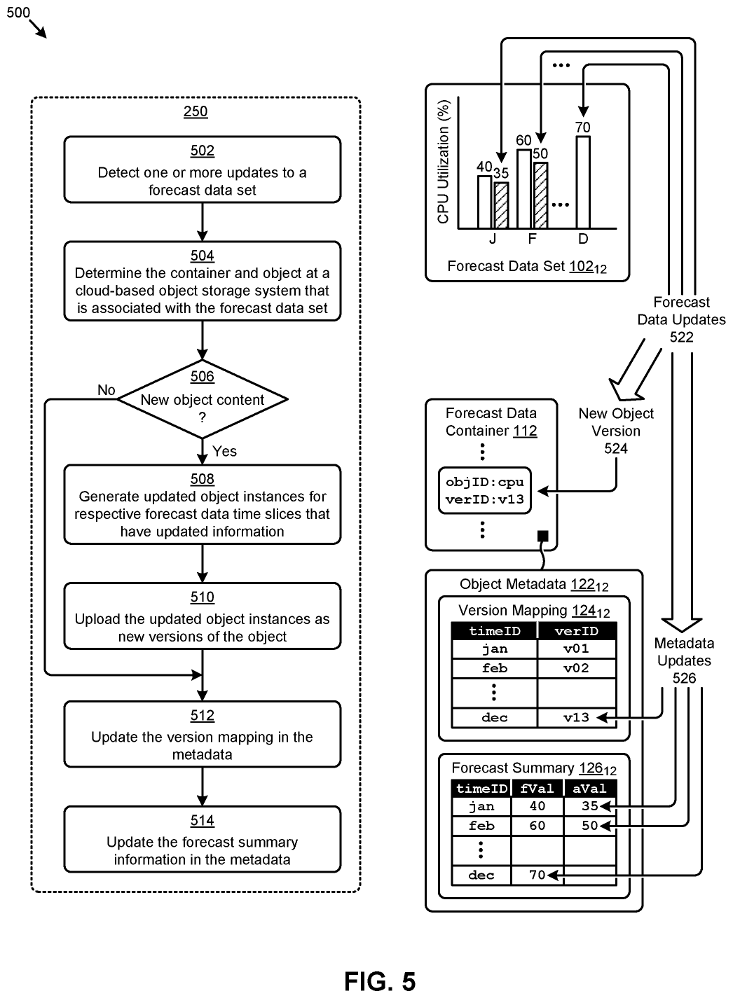

FIG. 5 depicts a forecast data object update technique 500 as implemented in systems that facilitate fine-grained management of forecast data in a cloud-based object storage environment. As an option, one or more variations of forecast data object update technique 500 or any aspect thereof may be implemented in the context of the architecture and functionality of the embodiments described herein. The forecast data object update technique 500 or any aspect thereof may be implemented in any environment.

FIG. 5 illustrates one aspect pertaining to accessing object metadata in a cloud-based object storage environment to map the versions of objects comprising forecast data to the time periods associated with the forecast data. Specifically, the figure is presented to illustrate one embodiment of certain steps and/or operations that facilitate updating object versions and/or object metadata associated with a forecast data object stored at a cloud-based object storage system in response to receiving one or more forecast data updates. A representative scenario is also shown in the figure to illustrate an example application of the forecast data object update technique 500.

The forecast data object update technique 500 can commence by detecting one or more updates to a forecast data set (step 502). For example, forecast data set 102₁₂ might be a forecast data set that is an updated instance of an earlier generated forecast data set. As shown, the forecast data set 102₁₂ comprises a set of forecast data updates 522 that include two actual values (e.g., derived from actual system observations); one for January (e.g., “35”) and one for February (e.g., “50”), and an updated forecast value (e.g., based at least in part on new system information) for December (e.g., “70”). A container and an object at a cloud-based object storage system that is associated with the updated forecast data set are determined (step 504). The container (e.g., via its container identifier) and the object (e.g., via its object identifier) are determined so as to facilitate access to the object content using, for example, an API message (e.g., HTTP call).

If the forecast data updates pertain to new object content (see “Yes” path of decision 506), updated object instances corresponding to respective forecast data time slices having updated information are generated (step 508) and uploaded as new versions of the object in the container (step 510). For example, as illustrated, the at least one updated forecast value of forecast data updates 522 results in the generation of at least one new object version 524 (e.g., version “v13”) in forecast data container 112. In this case, (when the “Yes” path of decision 506 is taken) the updated information may be stored in the object storage portion of the object version, or in metadata of the object version's container, or both. In some cases, the updated information can be combined with other forecast data to generate one or more calculated values.

If all new object versions are uploaded or if the forecast data updates do not pertain to new object content (see “No” path of decision 506), the version mapping in the metadata is updated (step 512). The forecast summary information in the metadata is also updated (step 514).

A set of metadata updates 526 include updates to version mapping 124₁₂ of object metadata 122₁₂. The shown updates include indications of the new mapping of the “dec” forecast data time slice to object version “v13”. Furthermore, metadata updates 526 include updates to forecast summary 126₁₂ of object metadata 122₁₂ to indicate the actual values and updated forecast values comprising forecast data updates 522.

In some embodiments, occurrences of forecast data updates 522 might include augmenting the object metadata with additional data items. For example, a forecast data update might add a data item pertaining to a trend, or a minimum value (e.g., a minimum value of a trend period), or a maximum value (e.g., a maximum value of a trend period), or an average value, etc. In some cases, one or more of the metadata updates 526 might be formed during the READ-MODIFY-WRITE operation to (1) READ a previously stored value, (2) MODIFY it, and (3) WRITE it back as a version in the object store. As such, running averages can be maintained by reading a previously-stored forecast value, performing an arithmetic or statistical operation on it, possibly in combination with additional information such as an updated forecast value, and storing the result in forecast summary 126₁₂. In some cases, the granularity of the forecast item can be coded into the time slice identifiers (e.g., associated with a “timeID” attribute) associated with a version. Strictly as a non-limiting example, a particular “timeID” attribute might be coded as “20181016-1301” to indicate a granularity in minutes, whereas a second “timeID” attribute might be coded as “20181016” to indicate a granularity in days, whereas a third “timeID” attribute might be coded as “201810” to indicate a granularity in months, whereas a fourth “timeID” attribute might be coded as “2018Q2” to indicate a granularity in calendar quarters and so on.

A fairly fine-grained degree of granularity (e.g., daily) might be applied when the forecast item pertains to decisions that are acted upon frequently, whereas a less fine-grained, or coarse degree of granularity (e.g., quarterly) might be applied when the forecast item pertains to decisions that are taken less frequently. It is possible that two or more “timeID” attributes share a common time indication. For example, one “timeID” attribute might be coded as “201810” to indicate the month of October 2018 and another “timeID” attribute might be coded as “20181001” to indicate the specific day Oct. 1, 2018. As such it is possible that two or more “timeID” attributes refer to the same start date.

The foregoing discussions include techniques for accessing the object versions and/or object metadata at a cloud-based object storage system to present certain forecast data at a user interface (e.g., step 260 of FIG. 2), which techniques are disclosed in further detail as follows.

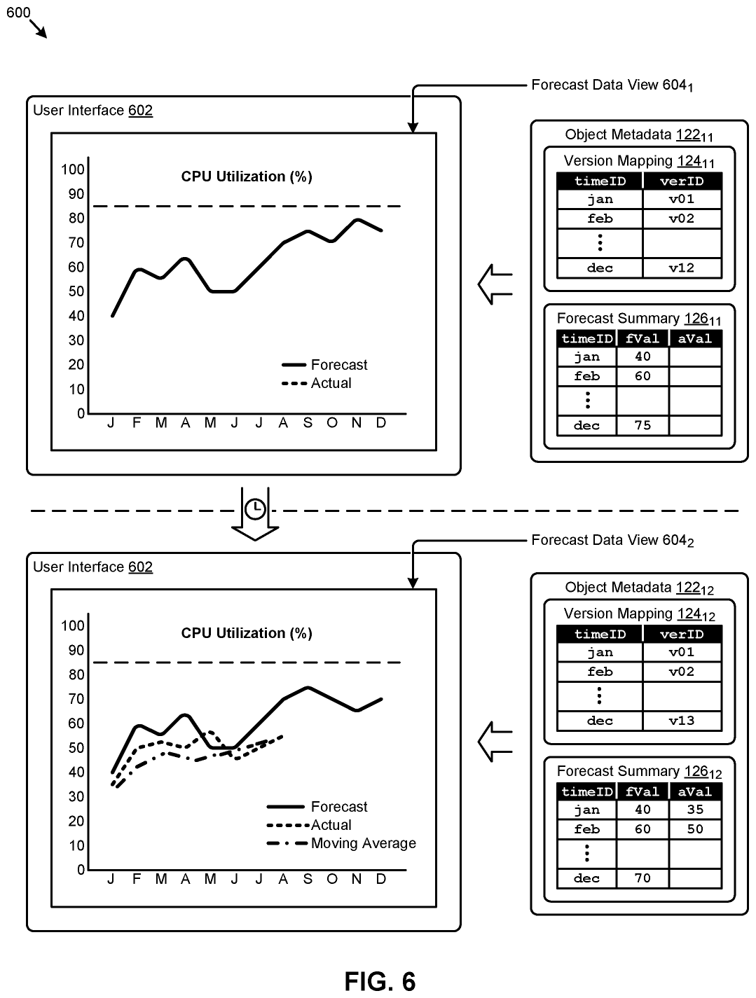

FIG. 6 illustrates a forecast data presentation technique 600 as implemented in systems that facilitate fine-grained management of forecast data in a cloud-based object storage environment. As an option, one or more variations of forecast data presentation technique 600 or any aspect thereof may be implemented in the context of the architecture and functionality of the embodiments described herein. The forecast data presentation technique 600 or any aspect thereof may be implemented in any environment.

FIG. 6 illustrates aspects pertaining to accessing object metadata in a cloud-based object storage environment to map the versions of objects comprising forecast data to the time periods associated with the forecast data. Specifically, the figure is presented to visually illustrate how the object versions and/or object metadata that store a forecast data set at a cloud-based object storage system according to the herein disclosed techniques can be accessed to present certain forecast data at a user interface.

At some first moment in time, object metadata 122₁₁ associated with an object at a cloud-based object storage system might be populated with attributes characterizing version mapping 124₁₁ and forecast summary 126₁₁. The content (e.g., object version) of the foregoing object might be associated with a forecast data set corresponding to a CPU utilization performance metric. As facilitated by the herein disclosed techniques, a forecast data view 604₁ at user interface 602 can be presented by merely accessing forecast summary 126₁₁ at object metadata 122₁₁. More specifically, in this illustrative embodiment, each forecasted value for a particular time period (e.g., a CPU utilization forecast for January, a CPU utilization forecast for February, etc.) that is displayed in forecast data view 604₁ is accessible from the metadata of the forecast data container without having to access the data of the object itself. As such, for the specific forecast data that is used in this specific display, since access to underlying object versions does not need to be performed, generating forecast data view 604₁ is an efficient operation.

If access to the underlying object versions of the object is required (e.g., to access additional forecast data that is not in the metadata), the herein disclosed techniques facilitate fine-grained access to forecast data time slices of the forecast data set using version mapping 124₁₁. Specifically, if there are further forecast data items (e.g., detailed forecast data) in addition to the forecast data items of the forecast summary, then the underlying object versions of the object can be accessed by the version identifier corresponding to respective time periods. Such additional data can be displayed in a user interface. Specifically, in the illustrative embodiment depicted by forecast data view 604₂, the forecast data items that are in addition to the forecast data of the forecast summary comprise data points corresponding to a moving average value. The individual data points corresponding to each value over time of the moving average is stored into respective time sliced object versions of the object, where each object version corresponds to a particular time or a particular time period. To construct the forecast data view 604₂ at user interface 602, both the data points of the object metadata 124₁₂ as well as data points from the object versions themselves are accessed, and the data points are displayed as curves over a span of time (e.g., from January through December, as shown).

Since the operations to access forecast data points are so efficient, the chart can be updated frequently. As such, at any moment in time, an updated instance of object metadata 122₁₂ associated with the object might be populated with attributes characterizing version mapping 124₁₂ and forecast summary 126₁₂. As facilitated by the herein disclosed techniques, an updated plot of forecast data view 604₂ at user interface 602 can be presented by again accessing forecast summary 126₁₂ of object metadata 122₁₂ to gather updated forecast data. As shown, the attributes of forecast summary 126₁₂ and the visual representation of the attributes in forecast data view 604₂ can facilitate comparisons of earlier forecasted data with respect to actual observed values and/or with respect to historical values and/or calculated values. Such comparisons can facilitate measurements and/or improvements (e.g., using machine learning) of the accuracy of one or more forecasting algorithms and/or predictive models.

### Additional Embodiments of the Disclosure

### Additional Practical Application Examples

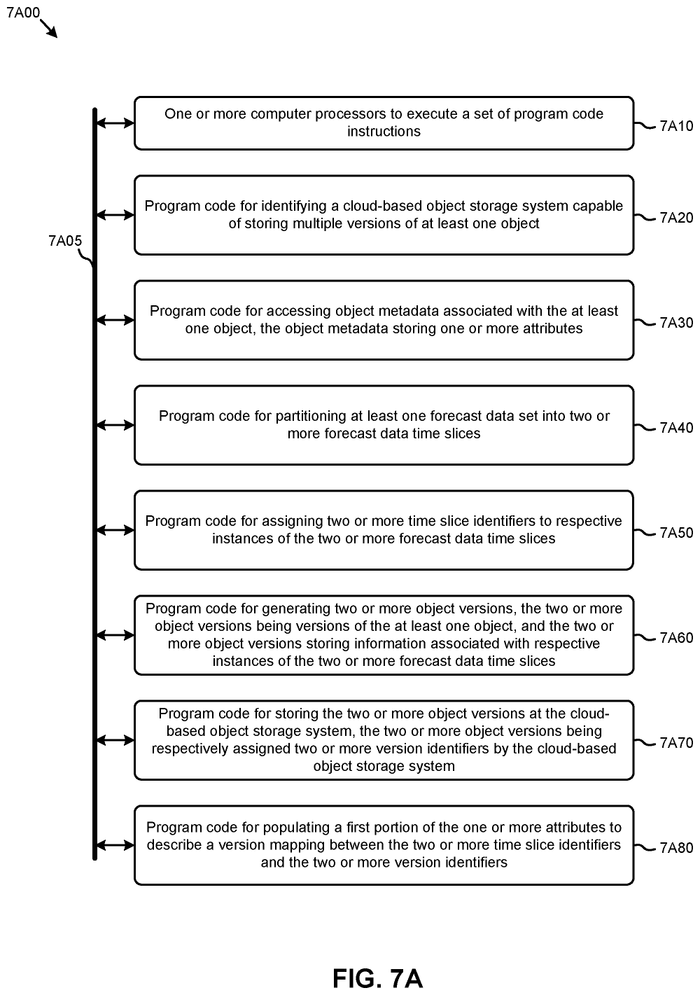

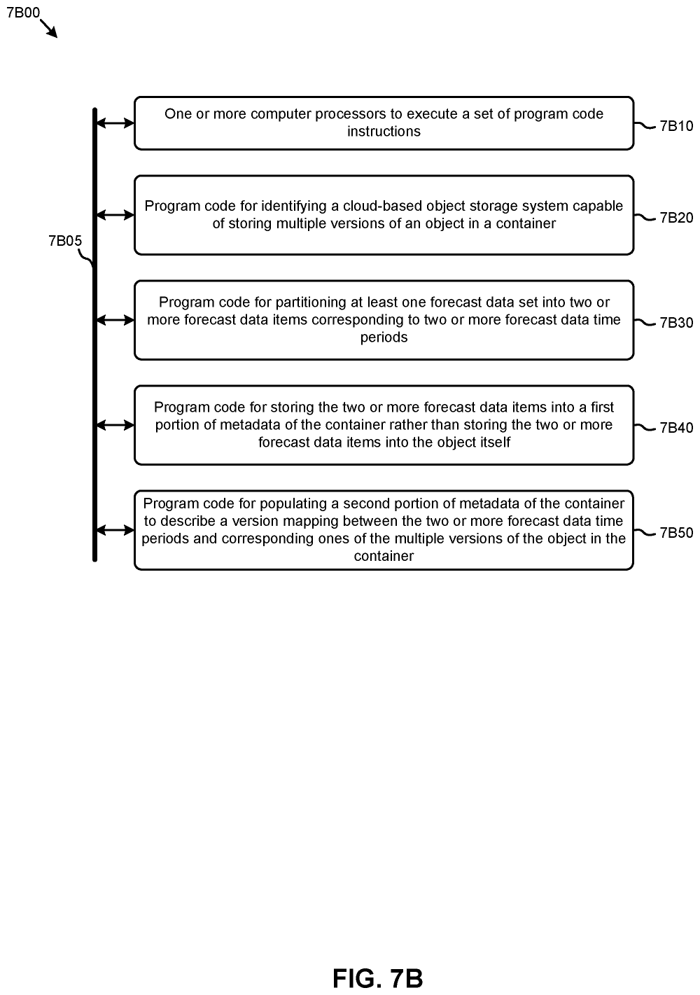

FIG. 7A depicts a system 7A00 as an arrangement of computing modules that are interconnected so as to operate cooperatively to implement certain of the herein-disclosed embodiments. This and other embodiments present particular arrangements of elements that, individually or as combined, serve to form improved technological processes that address efficiently managing large, highly dynamic forecast data sets stored in cloud-based object storage environments. The partitioning of system 7A00 is merely illustrative and other partitions are possible. As an option, the system 7A00 may be implemented in the context of the architecture and functionality of the embodiments described herein. Of course, however, the system 7A00 or any operation therein may be carried out in any desired environment.

The system 7A00 comprises at least one processor and at least one memory, the memory serving to store program instructions corresponding to the operations of the system. As shown, an operation can be implemented in whole or in part using program instructions accessible by a module. The modules are connected to a communication path 7A05, and any operation can communicate with any other operations over communication path 7A05. The modules of the system can, individually or in combination, perform method operations within system 7A00. Any operations performed within system 7A00 may be performed in any order unless as may be specified in the claims.

The shown embodiment implements a portion of a computer system, presented as system 7A00, comprising one or more computer processors to execute a set of program code instructions (module 7A10) and modules for accessing memory to hold program code instructions to perform: identifying a cloud-based object storage system capable of storing multiple versions of at least one object (module 7A20); accessing object metadata associated with the at least one object, the object metadata storing one or more attributes (module 7A30); partitioning at least one forecast data set into two or more forecast data time slices (module 7A40); assigning two or more time slice identifiers to respective instances of the two or more forecast data time slices (module 7A50); generating two or more object versions, the two or more object versions being versions of the at least one object, and the two or more object versions storing information associated with respective instances of the two or more forecast data time slices (module 7A60); storing the two or more object versions at the cloud-based object storage system, the two or more object versions being respectively assigned two or more version identifiers by the cloud-based object storage system (module 7A70); and populating a first portion of the one or more attributes to describe a version mapping between the two or more time slice identifiers and the two or more version identifiers (module 7A80).

Variations of the foregoing may include more or fewer of the shown modules. Certain variations may perform more or fewer (or different) steps and/or certain variations may use data elements in more or in fewer or in different operations.

FIG. 7B depicts a system 7B00 as an arrangement of computing modules that are interconnected so as to operate cooperatively to implement certain of the herein-disclosed embodiments. The partitioning of system 7B00 is merely illustrative and other partitions are possible. As an option, the system 7B00 may be implemented in the context of the architecture and functionality of the embodiments described herein. Of course, however, the system 7B00 or any operation therein may be carried out in any desired environment.

The system 7B00 comprises at least one processor and at least one memory, the memory serving to store program instructions corresponding to the operations of the system. As shown, an operation can be implemented in whole or in part using program instructions accessible by a module. The modules are connected to a communication path 7B05, and any operation can communicate with any other operations over communication path 7B05. The modules of the system can, individually or in combination, perform method operations within system 7B00. Any operations performed within system 7B00 may be performed in any order unless as may be specified in the claims.

The shown embodiment implements a portion of a computer system, presented as system 7B00, comprising one or more computer processors to execute a set of program code instructions (module 7B10) and modules for accessing memory to hold program code instructions to perform: identifying a cloud-based object storage system capable of storing multiple versions of an object in a container (module 7B20); partitioning at least one forecast data set into two or more forecast data items corresponding to two or more forecast data time periods (module 7B30); storing the two or more forecast data items into a first portion of metadata of the container rather than storing the two or more forecast data items into the object itself (module 7B40); and populating a second portion of metadata of the container to describe a version mapping between the two or more forecast data time periods and corresponding ones of the multiple versions of the object in the container (module 7B50).

Variations of the foregoing may include more or fewer of the shown modules. Certain variations may perform more or fewer (or different) steps and/or certain variations may use data elements in more or in fewer or in different operations. Still further, some embodiments include variations in the operations performed, and some embodiments include variations of aspects of the data elements used in the operations.

### System Architecture Overview

### Additional System Architecture Examples

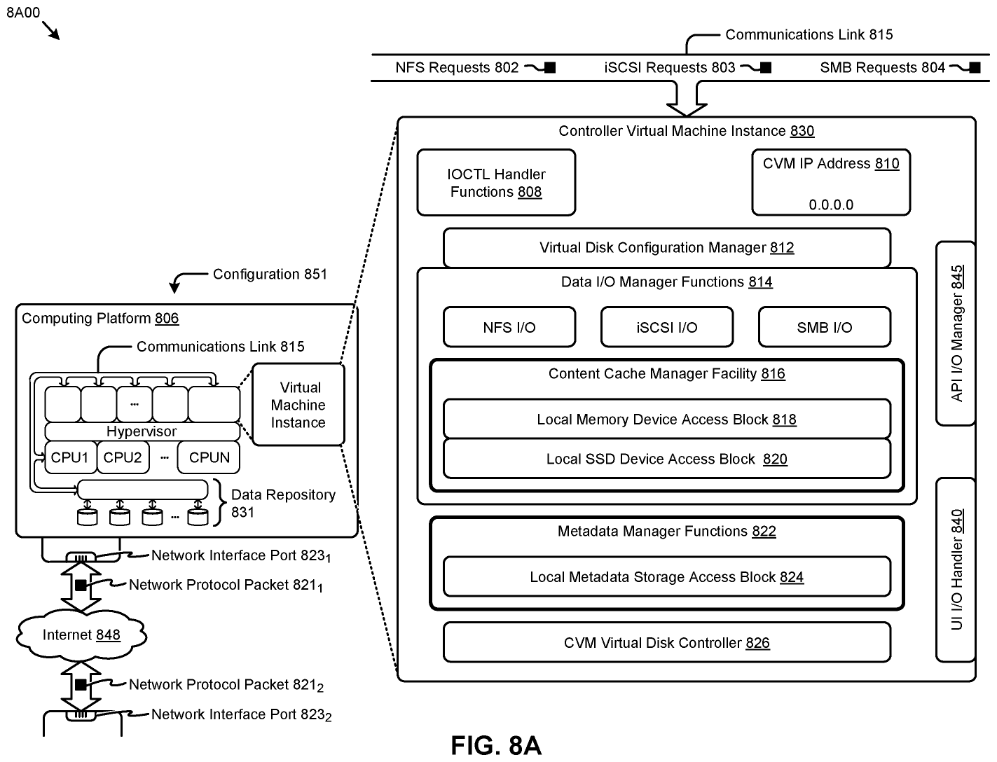

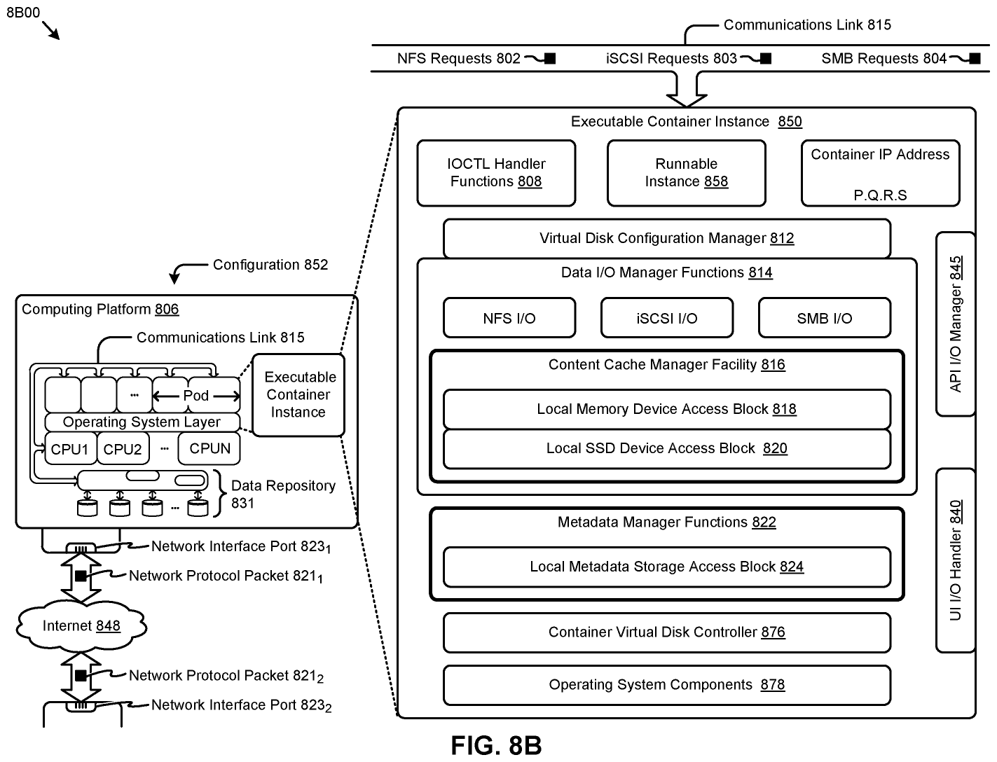

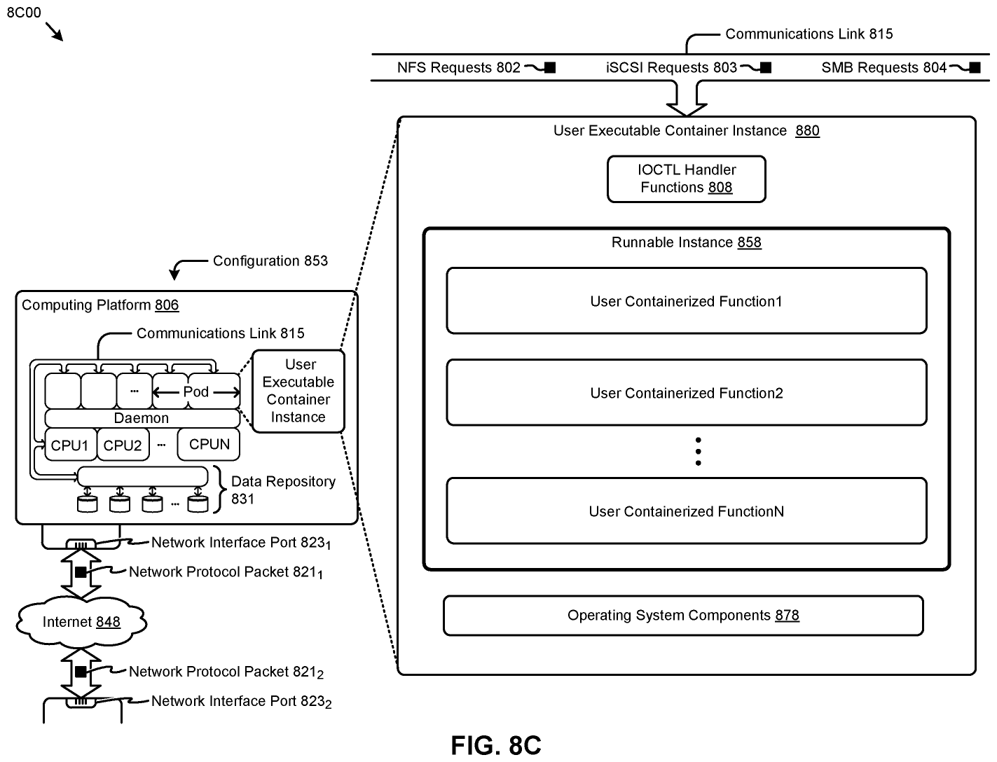

FIG. 8A depicts a virtualized controller as implemented by the shown virtual machine architecture 8A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high-performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 830.

In this and other configurations, a controller virtual machine instance receives block I/O storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data and the data repository may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or the results of executing program code can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to fine-grained management of forecast data when using cloud-based object storage. In some embodiments, a module may include one or more state machines and/or combinational logic used to implement or facilitate the operational and/or performance characteristics pertaining to fine-grained management of forecast data.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of fine-grained management of forecast data in a cloud-based object storage environment). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to fine-grained management of forecast data, and/or for improving the way data is manipulated when performing computerized operations pertaining to accessing object metadata in a cloud-based object storage environment (e.g., when mapping versions of objects comprising forecast data to respective time periods associated with the forecast data).

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container or as a controller executable container. Any executable container of any sort can be rooted in a directory system, and can be configured to be accessed by file system commands (e.g., “ls” or “ls-a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 880. Configuration 853 includes a daemon layer (as shown) that performs certain functions of an operating system.

User executable container instance 880 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 880.

The virtual machine architecture 8A00 of FIG. 8A and/or the containerized architecture 8B00 of FIG. 8B and/or the daemon-assisted containerized architecture 8C00 of FIG. 8C can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 851 of FIG. 8A) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method for fine-grained forecast data management, comprising:
partitioning a forecast data set into forecast data items corresponding to forecast data time periods;
storing the forecast data items into a first portion of metadata of a container, wherein the container is in a cloud-based object storage system capable of storing multiple versions of an object in the container rather; and
populating a second portion of metadata of the container to describe a version mapping between the forecast data time periods and corresponding ones of the multiple versions of the object in the container.

2. The method of claim 1, further comprising:
populating the first portion of the metadata of the container with an attribute to describe a forecast summary.

3. The method of claim 2, wherein the forecast summary comprises at least one of, a CPU utilization metric, a storage utilization metric, or a network bandwidth utilization metric.

4. The method of claim 1, further comprising:
detecting an update to the forecast data set; and
updating, in response to detecting the update, at least one attribute of the metadata.

5. The method of claim 4, further comprising:
generating, in response to detecting the update, a new object version; and
storing, in an object storage portion of the new object version, a forecast data item corresponding to the update one or more updates.

6. The method of claim 5, wherein the object storage portion of the new object version stores a historical value or a calculated value.

7. The method of claim 6, wherein at least one of the calculated value is a moving average value.

8. The method of claim 1, wherein the forecast data time periods are dates.

9. The method of claim 1, wherein at least one of the forecast data time periods corresponds to a past time period, a current time period, or a future time period.

10. A non-transitory computer readable medium having stored thereon a sequence of instructions which, when stored in memory and executed by a processor causes the processor to perform a set of acts for fine-grained forecast data management, the acts comprising:
partitioning a forecast data set into forecast data items corresponding to forecast data time periods;
storing the forecast data items into a first portion of metadata of a container, wherein the container is in a cloud-based object storage system capable of storing multiple versions of an object in the container; and
populating a second portion of metadata of the container to describe a version mapping between the forecast data time periods and corresponding ones of the multiple versions of the object in the container.

11. The computer readable medium of claim 10, further comprising instructions which, when stored in memory and executed by the processor causes the processor to perform acts of:
populating the first portion of the metadata of the container with an attribute to describe a forecast summary.

12. The computer readable medium of claim 11, wherein the forecast summary comprises at least one of, a CPU utilization metric, a storage utilization metric, or a network bandwidth utilization metric.

13. The computer readable medium of claim 10, further comprising instructions which, when stored in memory and executed by the processor causes the processor to perform acts of:
detecting an update to the forecast data set; and
updating, in response to detecting the update, at least one attribute of the metadata.

14. The computer readable medium of claim 13, further comprising instructions which, when stored in memory and executed by the processor causes the processor to perform acts of:
generating, in response to detecting the update, a new object version; and
storing, in an object storage portion of the new object version, a forecast data item corresponding to the update.

15. The computer readable medium of claim 14, wherein the object storage portion of the new object version stores a historical value or a calculated value.

16. The computer readable medium of claim 15, wherein at least one of the one or more calculated values is a moving average value.

17. The computer readable medium of claim 10, wherein the forecast data time periods are dates.

18. The computer readable medium of claim 10, wherein at least one of the forecast data time periods corresponds to a past time period, a current time period, or a future time period.

19. A system for fine-grained forecast data management, the system performed by at least one computer and comprising:
a storage medium having stored thereon a sequence of instructions; and
a processor that execute the instructions to cause the processor to perform a set of acts, the acts comprising,
partitioning a forecast data set into forecast data items corresponding to forecast data time periods;
storing the forecast data items into a first portion of metadata of a container, wherein the container is in a cloud-based object storage system capable of storing multiple versions of an object in the container; and
populating a second portion of metadata of the container to describe a version mapping between the forecast data time periods and corresponding ones of the multiple versions of the object in the container.

20. The system of claim 19, wherein the forecast data time periods are dates.

21. The method of claim 1, further comprising:
populating the first portion of the metadata of the container with an attribute to describe a forecast summary.

22. The method of claim 1, further comprising:
detecting an update to the forecast data set; and
updating, in response to detecting the update, at least one attribute of the metadata.

23. The method of claim 1, wherein at least one of the forecast data time periods corresponds to a past time period, a current time period, or a future time period.
